(19) United States
(12) Patent Application Publication
(10) Pub. No.: US 2022/0123777 A1
(43) Pub. Date: Apr. 21, 2022

(54) Protective case for a mobile device

(71) Applicant: Arsen Melikyan, Arcadia, CA (US)

(72) Inventor: Arsen Melikyan, Arcadia, CA (US)

(21) Appl. No.: 17/133,779

(22) Filed: Dec. 24, 2020

Related U.S. Application Data
(63) Continuation-in-part of application No. 29/755,602, filed on Oct. 21, 2020.

(51) Int. Cl. H04B 1/3888; A45C 1/06; A45C 11/18

(52) U.S. Cl. CPC H04B 1/3888; A45C 1/06; A45C 2011/002; A45C 2001/067; A45C 11/182

(57) ABSTRACT

A protective case for a mobile device includes a base member that consists of a frontside, backside, and side walls which are shaped to fit and hold a mobile phone, a plurality of openings for accessing ports of the mobile phone, and a wallet component on the backside that includes a lid that can be opened or remain closed by a pair of magnetic members. The cover structure also includes a cord insert that attaches to the frontside of the base member. The opposite end of the cord insert has one or more clamps that securely hold a cord that can be used for holding and carrying the mobile device.

### TECHNICAL FIELD

Embodiments disclosed herein relate generally to a mobile phone protective cover structure, and more specifically to mobile phone protective cover structure with a wallet.

### BACKGROUND ART

Various protective cases for mobile phones provide protective and reduce the amount of damage caused by regular day-to-day use. However, a protective case that provides the most protection is expensive and does not include additional functions aside from providing a protective layer for a mobile phone. These additional functions include a component that serves as a wallet and allows an individual to store money and cards without the need to have a separate item on their person. This function eliminates the need for a wallet and may reduce the chances of health-related back issues caused from keeping a wallet in a back pocket. Due to the size of most mobile phones, many individuals cannot keep their phone in their pocket forcing individuals to hold the mobile phone in an uncomfortable manner with their hand. A cord that attaches to a phone cover will allow a person to tie their mobile phone around themselves or another item without obstructing the use of a hand. Furthermore, reproducing a protective case makes it difficult to mass-produce in an efficient manner due to the material needed to protect a mobile phone. These reproduction issues become costly for the manufacturer since time is spent assuring the material is mass-produced.

Therefore, there is a need for a protective case which protects a mobile phone, but can also provide other functions such as storage of money or credit cards and other docs such as IDs, etc. and can be carried on an individual's person as well as being affordable to make and purchase, and can be mass produced efficiently.

### SUMMARY OF THE EMBODIMENTS

The present invention provides a protective cover for a mobile phone which includes a base member having a frontside, backside, sidewall shaped to fit and hold the mobile phone, a plurality of openings for accessing ports of the mobile phone, and a wallet component with a lid pivotally connected to the backside that can be opened or remain locked by at least one pair of magnetic members on the interior lid and wallet component. The protective cover also has a detachable cord insert that will allow a phone to be held on an individual's person using a cord.

The material and color of the base member of the protective cover may vary according to the embodiment, but will provide the same functionality in each embodiment. This protective cover could be a smooth plastic material as seen in FIG. 11.

In some instances, the interior lid will be permanently fused on the right side of the base member and the backside of the base member can contain a cutout on the left side of that will help a user open the lid of the wallet by placing a finger into the cutout and lifting the lid.

In some embodiments the magnetic member is placed on top of the interior lid and correspond with a magnetic member on the backside of the base member as seen in FIG. 10. In other embodiments, the magnetic member is embedded within the interior lid and the backside of the base member. In some embodiments there will be no magnetic members.

The cover structure also includes a cord insert with one side that attaches to the phone cover and another side that attaches to a cord. This cord insert locks with the frontside of the base member and is further locked due to the pressure placed when a phone is placed within the protective cover. In some instances, the cord insert can vary in shape and color. FIG. 13 shows a cord insert with a rectangular shape that attaches to a rectangular recess on the frontside of the base member. In other examples, the cover structure material can be metal or a different material. In other instances, a plurality of bumps is disposed on the backside of the base member.

The clamp end of the cord insert may also vary in shape and number of clamps. In some embodiments there may only be one clamp and the clamp may be square, in others as seen in FIG. 12, there may be two rounded clamps with semi-openings locking a cord within. Furthermore, the clamps may permanently encompass a cord, while in other instances the clamps may be semi-closed and allow for a cord to be removed. It will be understood by a person skilled in the art that the cord can be permanently attached with adhesion, hoops, or some other means, but can also be detachable as seen in FIG. 13.

Other aspects, embodiments and features of the device and method will become apparent from the following detailed description when considered in conjunction with the accompanying figures. The accompanying figures are for schematic purposes and are not intended to be drawn to scale. In the figures, each identical or substantially similar component that is illustrated in various figures is represented by a single numeral or notation. For purposes of clarity, not every component is labeled in every figure. Nor is every component of each embodiment of the device and method shown where illustration is not necessary to allow those of ordinary skill in the art to understand the device and method.

### BRIEF DESCRIPTION OF THE DRAWINGS

The preceding summary, as well as the following detailed description of the disclosed device and method, will be better understood when read in conjunction with the attached drawings. It should be understood, however, that neither the device nor the method is limited to the precise arrangements and instrumentalities shown.

FIG. 1 is a back perspective view of a mobile phone protective cover structure;

FIG. 2 is a front view of a mobile phone protective cover structure;

FIG. 3 is a back view of a mobile phone protective cover structure.

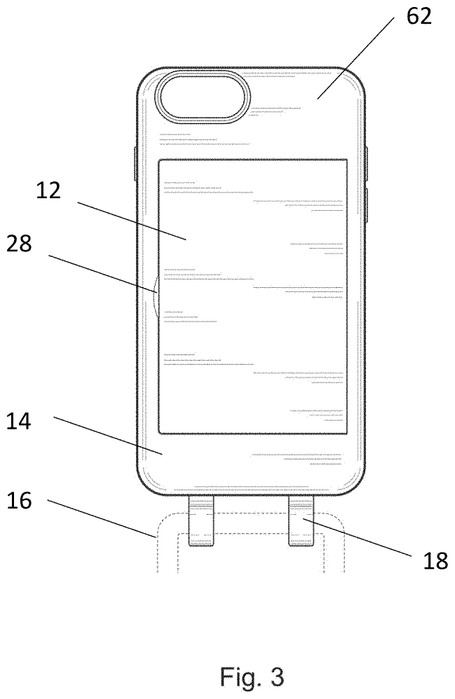

FIG. 4 is a left side view of a mobile phone protective cover structure.

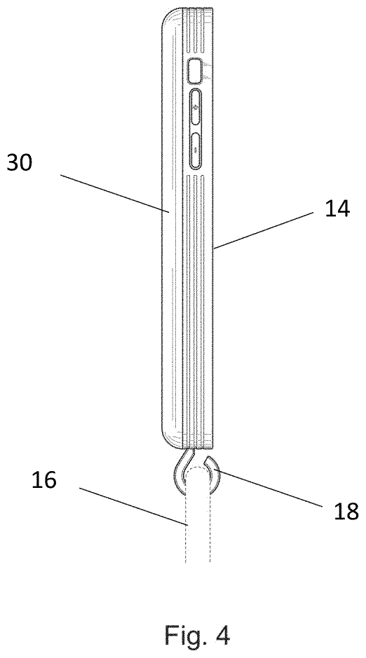

FIG. 5 is a right side view of a mobile phone protective cover structure.

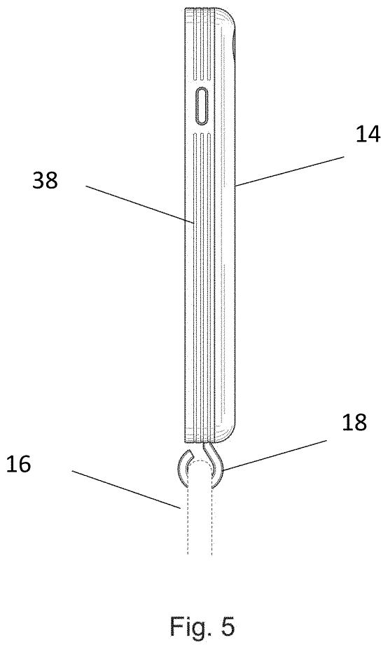

FIG. 6 is a top side view of a mobile phone protective cover structure.

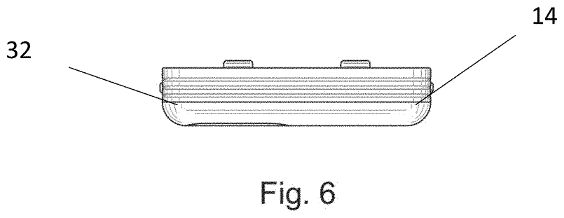

FIG. 7 is a bottom side view of a mobile phone protective cover structure.

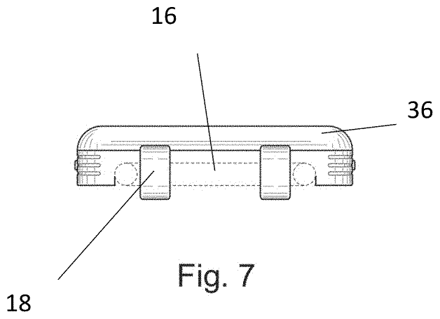

FIG. 8 is a front perspective view of a mobile phone protective cover structure showing an unattached cord insert and distal portion of the base membrane

FIG. 9 is a front view of a mobile phone protective cover structure with an alternative cord insert.

FIG. 10 is a back perspective view of a mobile phone protective cover with a lid in an open configuration.

FIG. 11 is a 3-dimensional back perspective view of a mobile phone protective cover with a lid in an open configuration without a cord insert and cord.

FIG. 12 is a 3-dimensional back perspective view of a mobile phone protective cover with a lid in an open configuration with a cord insert and cord.

FIG. 13 is a 3-dimensional front perspective view of the distal portion of the base member with corresponding cord inserts (one with a cord and another without a cord).

FIG. 14 is a 3-dimensional front perspective view of cord insert attached to a cord and not attached with a corresponding base member.

### DETAILED DESCRIPTION OF SPECIFIC EMBODIMENTS

A person skilled in the art will appreciate that the devices and methods disclosed herein can be implemented using any type of mobile devices, such as mobile phones, personal digital assistants (PDAs), tablets, e-readers, smartphones and the like.

The present invention provides a protective cover having a base member that contains a wallet component on the backside as well as a cord insert. The cord insert positions into a recess on the frontside on one end and contains one or more clamps on another end that connect with a cord. When a mobile phone is placed in this phone cover, an individual will be able to securely stores cash and cards and the mobile phone and will be able to hang their phone on their neck or arm.

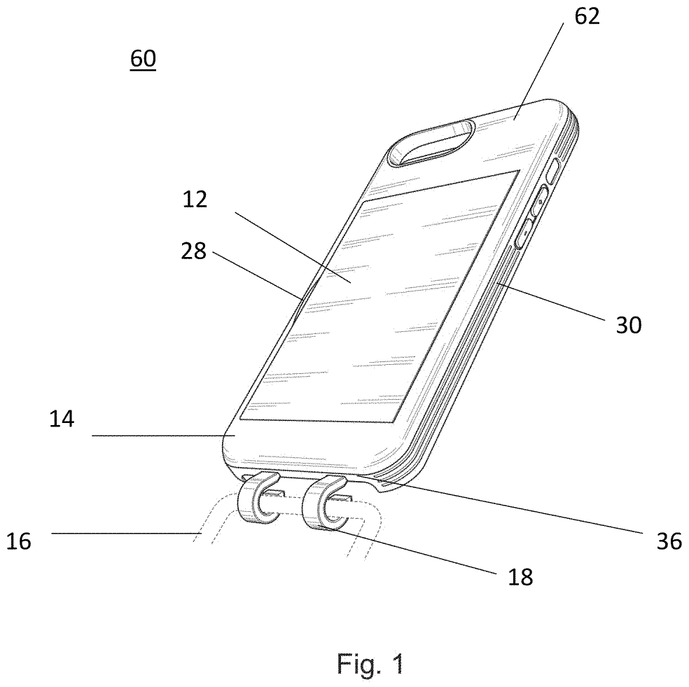

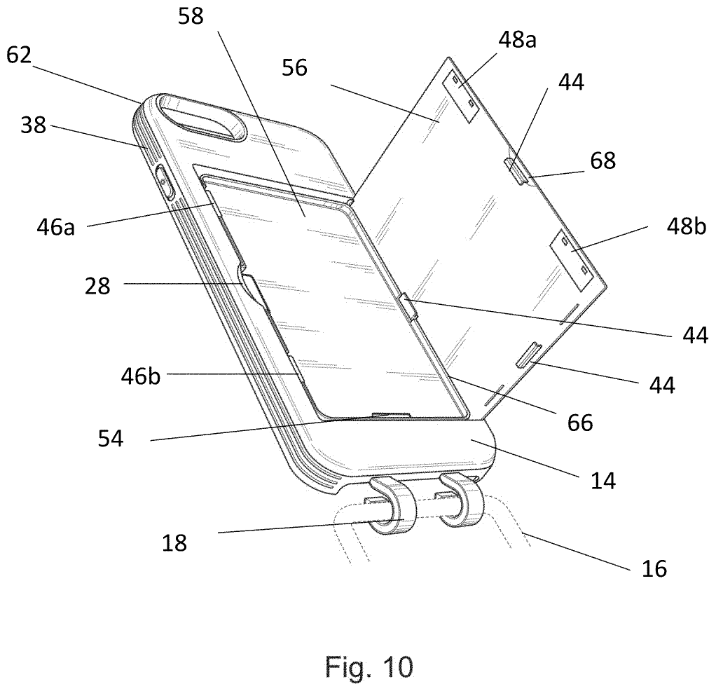

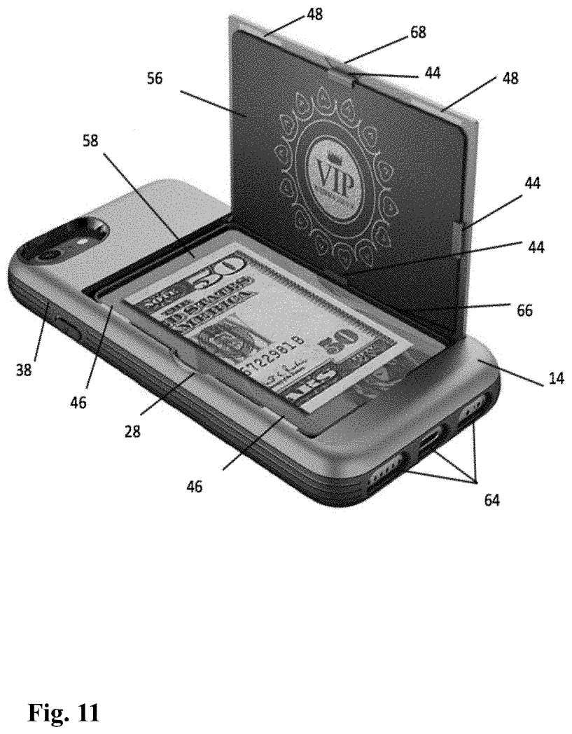

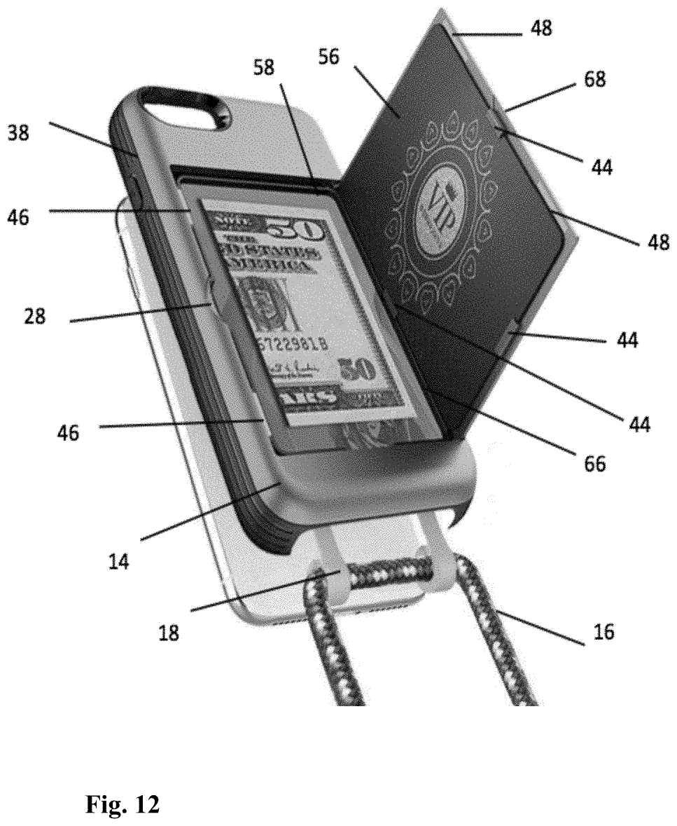

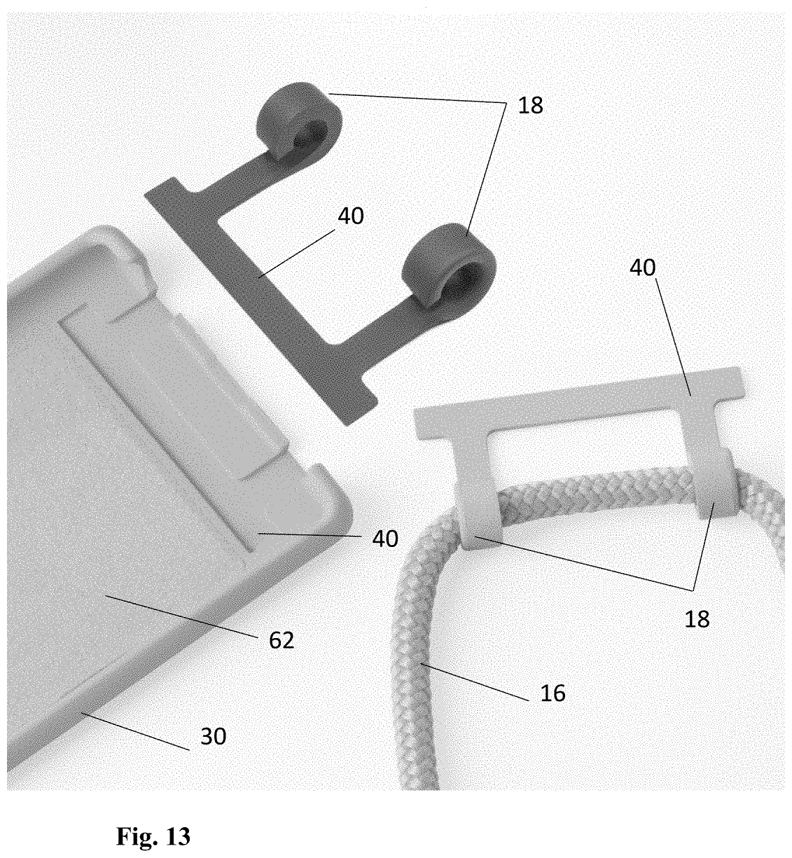

Referring now to the drawings in detail, and particularly to FIG. 1, there is shown a back perspective view of a protective case 60 for a mobile phone with the wallet component lid closed. The base member 14 contains a wallet component that is closed off by a lid 12, which can be opened by a user by placing a finger into a cutout 28 disposed on the left side of the backside of the base member 14 and subsequently lifting the lid 12, as shown in FIGS. 10-12. The base member includes backside 62, frontside 26, sidewalls (30, 32, 36, and 38) shaped to fit and hold the mobile phone with a plurality of openings 64 for accessing ports of the mobile phone. At least one magnetic member 48a placed on top of the interior lid 56 that closes the lid working with a corresponding magnetic member 46a on the back wall of the base member 14, as shown in FIG. 11. The magnetic members on the interior lid 48 and the magnetic members 46 on the back wall of the base member 14 work in unison to maintain the lid closed. In some instances, there could be more than one magnetic member disposed on each corresponding side. For example, magnetic members 48a and 48b on the interior lid 56 and corresponding magnetic members 46a and 46b on the back wall of the base member 14, as shown in FIG. 10. In some instances, magnetic members 48 can be magnets and corresponding magnetic members 46 can be made of metal. Conversely, magnetic members 48 can be made of metal and corresponding magnetic members 46 can be magnets. The phone cover also has one or more cord-holding members 18 that securely hold a circular cord 16 as shown in FIG. 13. The magnets should have the field strength in the range from 300 to 3,000 gauss in order not to damage high-coercivity magnetic strips on credit cards. In some instances, the magnets should have the field strength of less than 300 gauss to prevent from demagnetizing magnetic strips of low-coercivity, such as hotel keys or gift cards, for example.

In some embodiments the cord-holding members may take on a different shape such as a square. The cord could also be a different shape aside from the standard circular cord. According to some embodiments of the present invention, the backside of the wallet component can include one or more sleeves adapted to receive credit cards or other documents to maximize storage capacity.

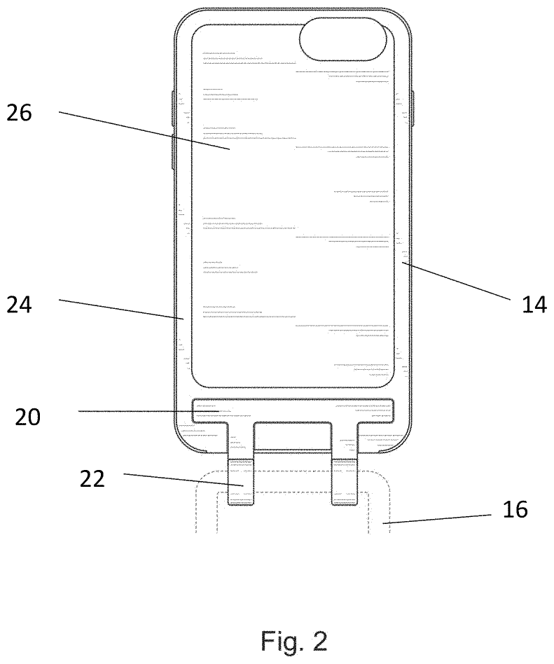

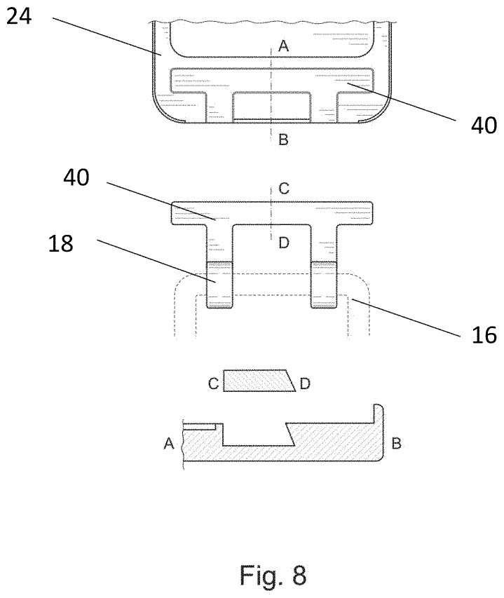

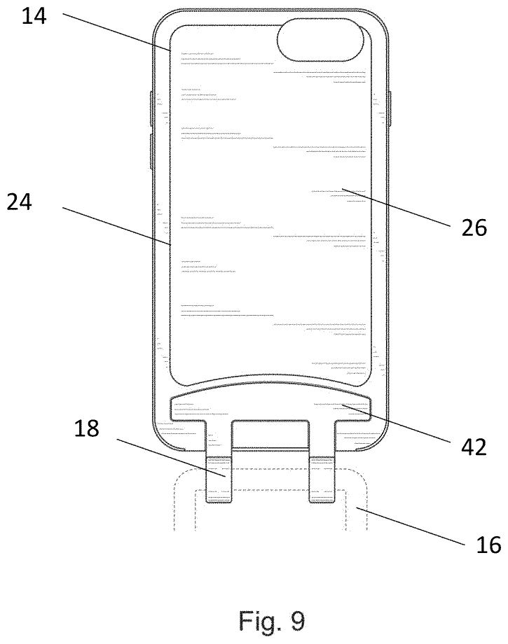

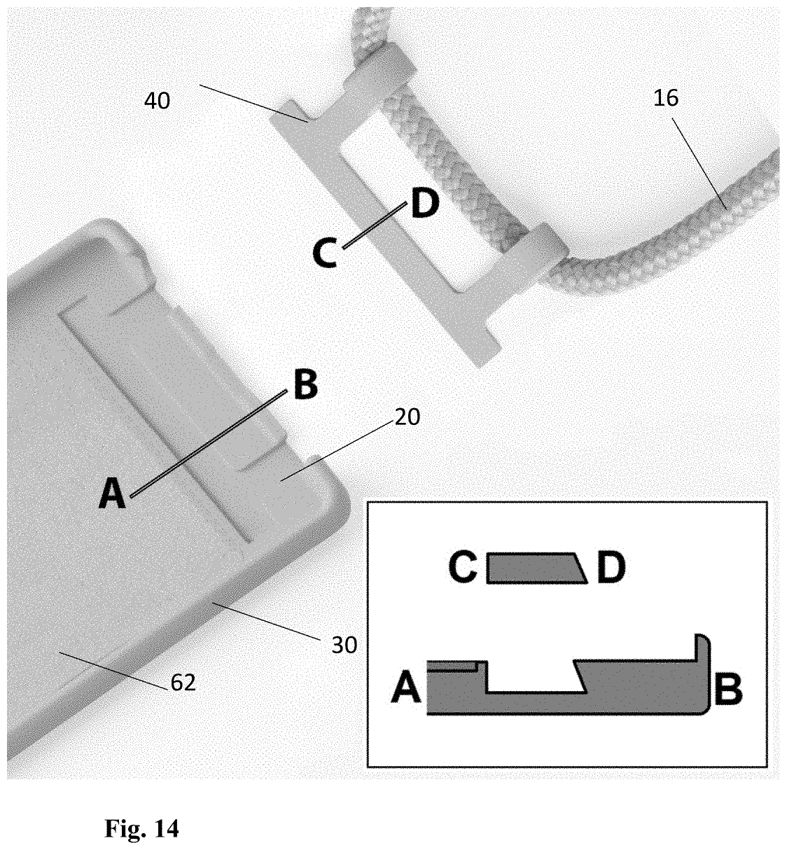

As illustrated in FIG. 8, there is shown a front view and a sideways view of the cord insert 40 securely attached to the base member. As illustrated in FIG. 2, the cord insert 40 securely fits with the recess of the frontside 20 of the base membrane. Please note that the cord insert and corresponding recess on the membrane may come in different shapes. Please see FIG. 9 demonstrating that the cord insert is semi-oval shaped 42 and is inserted into the recess of the frontside of the base membrane that shares the same semi-oval shape, but maintain the same attachment function. In order to tightly fit the cord insert 40 into the recessed area 20, one of the sidewalls of the recessed area 20 and corresponding sidewall of the cord insert 40 can be shaped at an angle as illustrated in FIG. 14. It will be appreciated by a person skilled in the art, that the corresponding sidewalls of the recessed area 20 and the cord insert cord 40 can also be made at a 90 degree angle (not shown).

FIG. 10, there is shown a back perspective view of a protective case 60 with the wallet component lid open. In some embodiments, the interior lid of the wall component 48 may be embedded with a magnetic component. The magnetic components can be any suitable form of magnets such as rare earth magnets, iron magnets or the like. In some embodiments, the corresponding magnetic components of the base member are not magnets and may include metal or steel. Therefore, any suitable arrangement of magnetic components can be used to realize the magnetic attraction within the wallet component.

In some embodiments, the interior of the lid 56 can be permanently fused with the right side of the base member. The interior lid also holds clamps 44 that have some height and allows for storage of additional cards. By placing a thumb into the cutout 28 on the backside of the base member 14 and lifting the lid an individual is able to prop a closed lid open.

The base member can be made from a variety of different materials such as metal, plastic, silicone, polycarbonate (PC), thermoplastic polyurethane (TPU) or any other suitable materials such as leather, faux leather, wood, carbon fiber, fabric. The base member can be made using various processing methods such as injection molding, for example.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

Although the invention is described herein with reference to specific embodiments, various modifications and changes can be made without departing from the scope of the present invention as set forth in the claims below. Accordingly, the specification and figures are to be regarded in an illustrative rather than a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements.

The foregoing detailed description is merely exemplary in nature and is not intended to limit the invention or application and uses of the invention. Furthermore, there is no intention to be bound by any expressed or implied theory presented in the preceding technical field, background, brief summary, or the following detailed description.

What is claimed is:

1. A protective case for a mobile device comprising:
a base member having a frontside, backside and a sidewall shaped to fit and hold a mobile device and a plurality of openings for accessing ports of the mobile device; and
a wallet compartment attached to the backside of the base member.

2. The protective case of claim 1, wherein the wallet compartment is detachably attached to the backside of the base member.

3. The protective case of claim 1, wherein the wallet compartment is permanently attached to the backside of the base member.

4. The protective case of claim 1, wherein the wallet compartment further comprising a lid that is pivotally connected to the wallet compartment.

5. The protective case of claim 4, wherein the interior side of the lid comprises one or more clamps for receiving and storing one or more cards.

6. The protective case of claim 4, wherein the interior side of the lid comprises one or more magnetic members.

7. The protective case of claim 6, wherein the one or more magnetic members protrude from the surface of the interior side of the lid.

8. The protective case of claim 6, wherein the one or more magnetic members are flush with the surface of the interior side of the lid.

9. The protective case of claim 6, wherein one or more magnetic members correspond with one or more metal members disposed on the backside of the base member.

10. The protective case of claim 1, wherein the backside of the wallet component further comprising one or more sleeves adapted to receive and store one or more cards.

11. The protective case of claim 1, wherein a first lock component is disposed on the backside of the wallet component and locks with a corresponding second lock component disposed on the interior side of the lid.

12. The protective case of claim 1, wherein the distal portion of the frontside of the base member further comprises a recessed area configured to receive and hold in place a cord insert.

13. The protective case of claim 12, wherein said cord insert further comprising one or more cord holding members for receiving and holding a cord.

14. The protective case of claim 13, wherein the cord is permanently attached to one or more cord holding members.

15. The protective case of claim 13, wherein the cord is detachably attached to one or more cord holding members.

16. The protective case of claim 12, wherein the recessed area and the cord insert each have at least one slanted sidewall of the same angle.

17. The protective case of claim 4, wherein the backside of the base member further comprising a cutout to help a user open the lid by inserting a finger into the cutout and lifting the lid.
